(19) United States
(12) Patent Application Publication
(10) Pub. No.: US 2015/0280258 A1
(43) Pub. Date: Oct. 1, 2015

(54) CATHODE GAS RECIRCULATION METHOD AND SYSTEM FOR FUEL CELLS

(71) Applicant: NUVERA FUEL CELLS, INC., Billerica, MA (US)

(72) Inventors: Antonio Maggiore, Milan (IT); Giampaolo Sibilia, Milan (IT); Paolo Zucchi, Gorgonzola Milan (IT)

(73) Assignee: NUVERA FUEL CELLS, INC., Billerica, MA (US)

(21) Appl. No.: 14/662,273

(22) Filed: Mar. 19, 2015

Related U.S. Application Data
(60) Provisional application No. 61/971,179, filed on Mar. 27, 2014.
(60) Provisional application No. 61/986,753, filed on Apr. 30, 2014.

(51) Int. Cl. H01M 8/04

(52) U.S. Cl. CPC H01M 8/04097

(57) ABSTRACT

The cathode recirculation system for a fuel cell module may include an inert gas inlet passage configured to receive inert gas and an oxygen gas inlet passage configured to receive oxygen, a blending component in fluid communication with the inert gas inlet passage, the oxygen gas inlet passage, and an inlet of at least one cathode, and a recirculation line in fluid communication with an outlet of the at least one cathode and the blending component configured to recirculate a mixed gas stream containing oxygen and an inert gas. At least a portion of the mixed gas released from the at least one cathode may be recirculated back to the blending component where oxygen, inert gas, or both oxygen and inert gas are introduced into the recirculated mixed gas stream and then supplied to the inlet of the at least one cathode.

This application claims the benefit of U.S. Provisional Application No. 61/971,179, filed Mar. 27, 2014, and U.S. Provisional Application No. 61/986,753, filed on Apr. 30, 2014, each of which is incorporated by reference in their entirety.

The present disclosure is directed towards a cathode gas recirculation system and method for fuel cell modules, and more particularly, to fuel cells applications where ambient air is unavailable.

For many fuel cell applications the surrounding environment provides an abundant supply of oxygen in the ambient air to supply to the cathode of the fuel cell (e.g., proton exchange membrane fuel cell) as an input component of the electrochemical reaction. However, in certain applications feeding oxygen by way of the ambient air from the surrounding environment to the fuel cell is not practical or in some cases not possible. For example, operating underwater (e.g., a submarine) or operating in outer space (e.g., a space craft) are applications where ambient air from the environment is unavailable.

For applications such as this pure oxygen is commonly stored for various purposes and may be supplied to the cathode of the fuel cell as a substitute for ambient air. However, supplying the cathode pure oxygen has drawbacks. For example, feeding pure oxygen to the cathode may necessitate the fuel cell meeting certification for oxygen use standards, which can substantially increase the cost and complexity of the fuel cell. In addition, using pure oxygen can raise safety issues. For example, pinhole leaks in the fuel cell membrane or high rate cross-over can cause the formation of an explosive mixture (e.g., oxygen and hydrogen). In light of these issues, standard fuel cell designs and technology are incompatible and therefore complex custom designs are needed for these applications.

It is accordingly an object of the present disclosure to provide a cathode gas recirculation system for fuel cell modules and method of operation that enables use of standard proton exchange membrane (PEM) fuel cell designs for pure oxygen supply applications. The system and method includes recirculating an inert gas stream (e.g., N₂) through the cathode and mixing it with the pure oxygen so that the one or more fuel cells are exposed to an inert gas rich gas stream rather than a pure oxygen stream.

In one aspect, the present disclosure is directed to a cathode recirculation system for a fuel cell module. The cathode recirculation system can include an inert gas inlet passage configured to receive inert gas and an oxygen gas inlet passage configured to receive oxygen, a blending component in fluid communication with the inert gas inlet passage, the oxygen gas inlet passage, and an inlet of at least one cathode, and a recirculation line in fluid communication with an outlet of the at least one cathode and the blending component configured to recirculate a mixed gas stream containing oxygen and an inert gas, wherein at least a portion of the mixed gas released from the at least one cathode is recirculated back to the blending component where oxygen, inert gas, or both oxygen and inert gas are introduced into the recirculated mixed gas stream and then supplied to the inlet of the at least one cathode.

In another embodiment, the inert gas can be nitrogen. In another embodiment, the ratio of oxygen to inert gas in the mixed gas stream entering the at least one cathode ranges from about 10:90 to about 40:60. In another embodiment, the cathode recirculation system may further include a separator configured to remove water vapor from the mixed gas stream released from the at least one cathode. In another embodiment, the cathode recirculation system may further include a plurality of valves, instruments, and controllers configured to control the pressure of the mixed gas stream supplied to the inlet of the at least one cathode.

In another embodiment, the blending component can comprise an ejector. In another embodiment, the cathode recirculation system can include a compressor in stream with the recirculation line configured to compress the mixed gas. In another embodiment, the cathode recirculation system can include at least one heat exchanger configured to regulate the temperature of the mixed gas. In another embodiment, the fuel cell module can house at least one proton exchange membrane fuel cell. In another embodiment, the moles of oxygen supplied through the blending component to the mixed gas is substantially equal to the moles of oxygen consumed in the at least one cathode.

In another aspect, the present disclosure is direct to a method of recirculating a mixed gas through a cathode of a fuel cell. The method can include feeding a mixed gas stream to the cathode, wherein the mixed gas stream comprises oxygen and an inert gas, collecting a depleted mixed gas stream from the cathode, and adding oxygen, inert gas, or both oxygen and inert gas to the depleted mixed gas stream and recirculating to the inlet of the cathode as the mixed gas stream.

In another embodiment, the method can include wherein the inert gas is nitrogen. In another embodiment, the method can include wherein the ratio of oxygen to inert gas in the mixed gas stream entering the at least one cathode ranges from about 10:90 to about 40:60. In another embodiment, the method can further include removing water vapor for the depleted mixed gas stream using a separator. In another embodiment, the method can further include controlling the pressure of the mixed gas stream supplied to the inlet of the at least one cathode.

In another embodiment, the method can further include ejecting the oxygen, inert gas, or both into the depleted mixed gas stream through an ejector. In another embodiment, the method can further include compressing the depleted mixed gas stream discharged from the at least one cathode. In another embodiment, the method can further include cooling the depleted mixed gas stream to maintain a temperature set point. In another embodiment, the method can further include controlling the amount of oxygen addition such that the moles of oxygen added to the depleted mixed gas stream corresponds to the amount consumed in the cathode.

In another aspect, the present disclosure is directed to a fuel cell module housing having at least one fuel cell containing a cathode and an anode. The fuel cell module housing can include an inert gas stream and an oxygen stream, a blending component in fluid communication with the inert gas stream and the oxygen stream, and a depleted mixed gas stream released from the cathode of the at least one fuel cell that is in fluid communication with the blending component, wherein at least a portion of the depleted mixed gas stream released from an outlet of the cathode is recirculated back to the blending component where the inert gas stream, the oxygen stream, or both are configured to be introduced into the depleted mixed gas stream and supplied to an inlet of the cathode.

Objects and advantages of the present disclosure will be set forth in part in the description which follows, and in part will be obvious from the description, or may be learned by practice of the present disclosure. The objects and advantages of the present disclosure will be realized and attained by means of the elements and combinations particularly pointed out in the appended claims.

It is to be understood that the following detailed description is exemplary and explanatory only and are not restrictive of the present disclosure as claimed.

The accompanying drawings, which are incorporated in and constitute a part of this specification, illustrate embodiments of the present disclosure and together with the description, serve to explain the principles of the present disclosure.

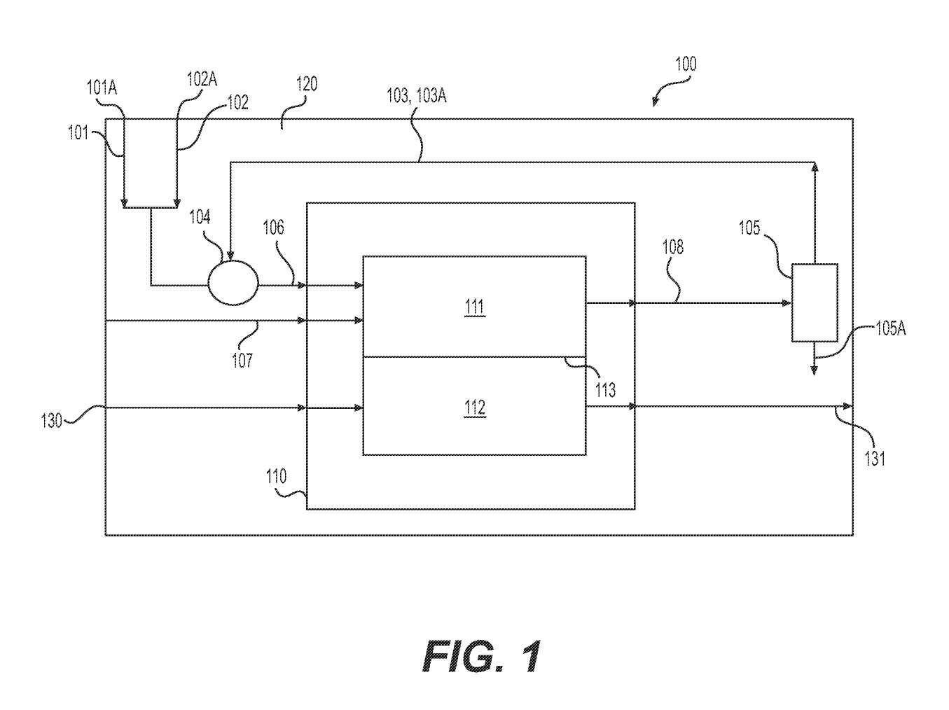

FIG. 1 shows a flow schematic of a fuel cell module, according to an exemplary embodiment.

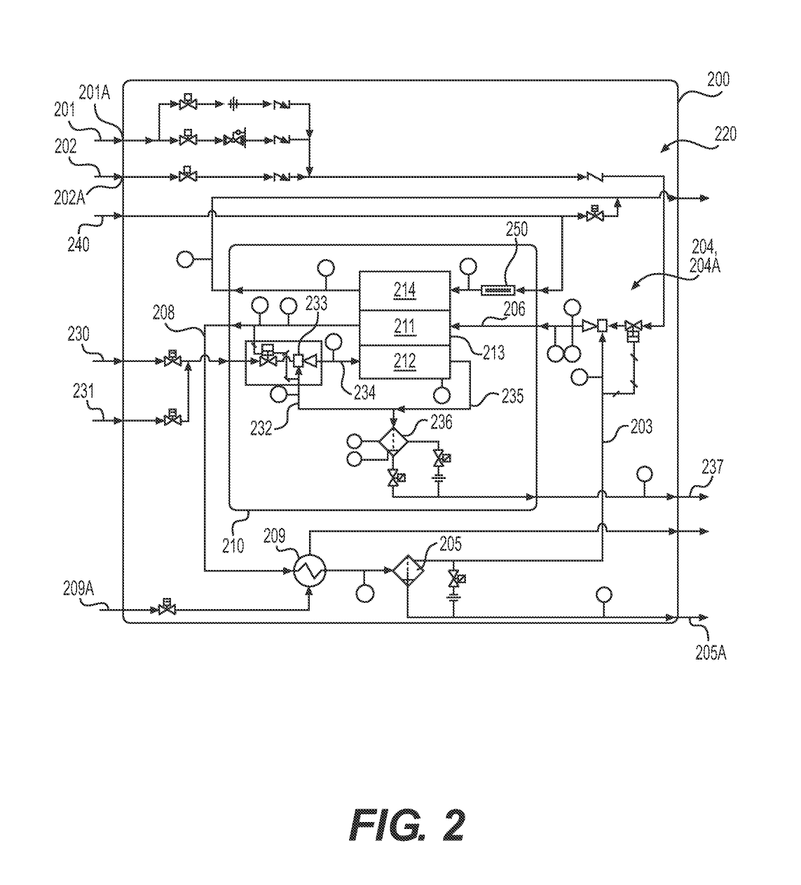

FIG. 2 shows a flow schematic of a fuel cell module, according to an exemplary embodiment.

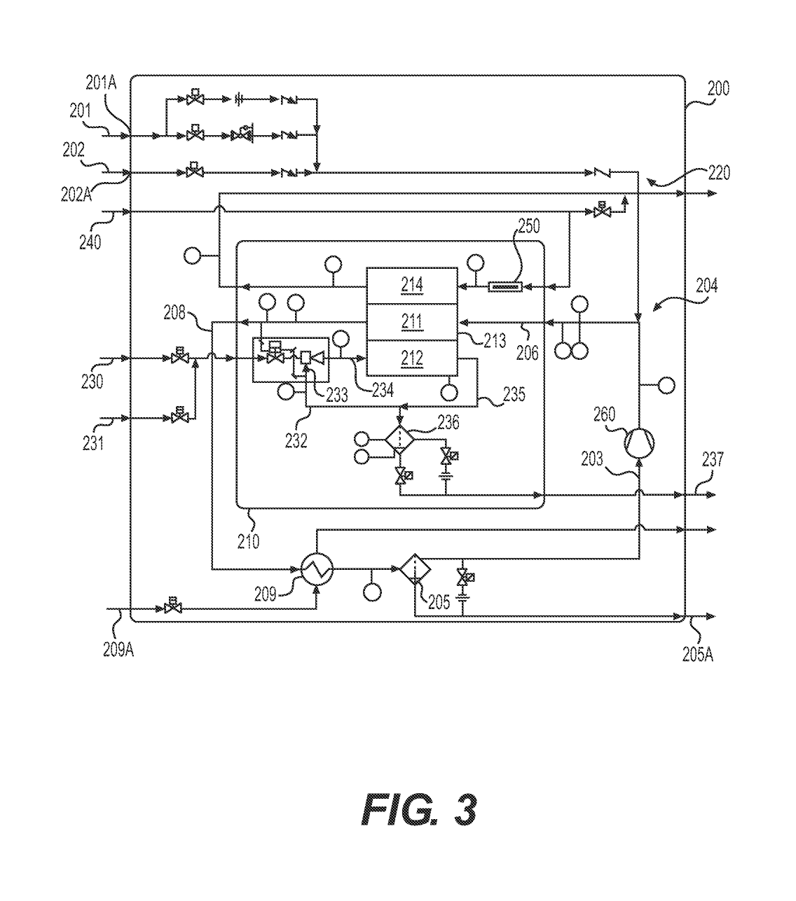

FIG. 3 shows a flow schematic of a fuel cell module, according to an exemplary embodiment.

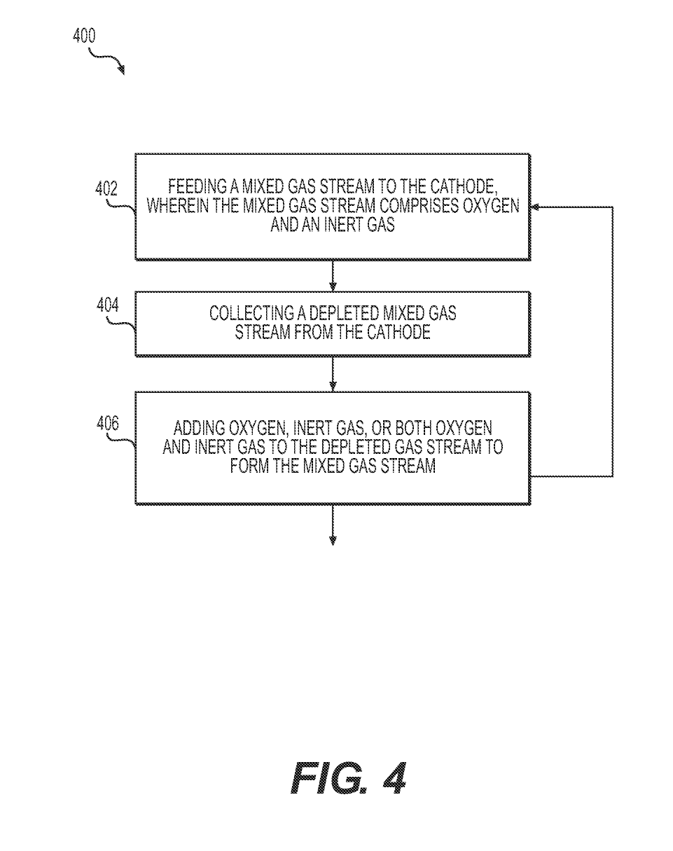

FIG. 4 shows a flow chart of a method of operating a fuel cell module configured for cathode gas recirculation, according to an exemplary embodiment.

Reference will now be made in detail to the exemplary embodiments of the present disclosure, examples of which are illustrated in the accompanying drawings. Wherever possible, the same reference numbers will be used throughout the drawings to refer to the same or like parts.

The present disclosure is described herein with reference to illustrative embodiments. It is understood that the embodiments described herein are not limited thereto. Those having ordinary skill in the art and access to the teachings provided herein will recognize additional modifications, applications, embodiments, and substitution of equivalents that all fall with the scope of the present disclosure.

FIG. 1 shows a schematic diagram of a fuel cell module 100 comprising a fuel cell 110 and a cathode recirculation system 120, according to an exemplary embodiment. Cathode recirculation system 120 can comprise an inert gas stream 101 configured to be received through inert gas inlet passage 101A, an oxygen stream 102 configured to be received through oxygen inlet passage 102A, a mixed gas recirculation stream 103 circulated through a recirculation line 103A, a blending component 104, and a separator 105. In other embodiments, fuel cell module 100 can comprise a plurality of fuel cells 110 forming a fuel cell stack within fuel cell module 100. For example, fuel cell module 100 can contain 5, 10, 20, 25, 50, 100, or more fuel cells within fuel cell module 100 connected, for example, in parallel with one another.

According to an exemplary embodiment, fuel cell 110 installed within fuel cell module 100 can be a variety of different fuel cell configurations. For example, fuel cell 110 can be a proton exchange membrane (PEM) fuel cell or other similar fuel cells where oxygen can be an input of the reaction at the cathode. As shown in FIG. 1, fuel cell 110 can comprise a cathode 111 and an anode 112 separated by an electrolyte membrane 113.

For the purposes of this description it will be assumed fuel cell 110 is a PEM fuel cell. However, as described herein, this disclosure is not limited to PEM fuel cells. As is known in the art, for a PEM fuel cell, hydrogen atoms can be electrochemically split into electrons and protons (hydrogen ions) at anode 112. The electrons produced by the reaction flow through an electric load circuit (not shown in FIG. 1) to cathode 111, producing direct-current electricity. The protons produced by the electrochemical reaction diffuse through electrolyte membrane 113 to cathode 111. Electrolyte 113 can be configured to prevent the passage of negatively charged electrons while allowing the passage of positively charged ions. Following passage of the protons through electrolyte 113, the protons at cathode 111 can react with electrons that have passed through the electric load circuit and oxygen supplied to cathode 111 to produce heat and water.

According to an exemplary embodiment, fuel cell module 100 can be configured to supply a mixed gas stream 106 to cathode 111 from blending component 104. According to an exemplary embodiment, mixed gas stream 106 can comprise a mixture of inert gas and oxygen. In addition, according to some embodiments, fuel cell module 100 can be configured to supply cathode 111 with a water vapor stream 107 to regulate the humidity within cathode 111 and fuel cell 110.

According to an exemplary embodiment, the inert gas of inert gas stream 101 can be, for example, nitrogen or other like gas. According to an exemplary embodiment, the percentage of oxygen in mixed gas stream 106 can be about 21% and the percentage of inert gas can be about 79%. In other embodiments, the percent of oxygen and inert gas making up mixed gas stream 106 can vary. For example, inert gas can comprise less than about 90%, 80%, 70%, 60%, 50%, 40%, 30%, 20%, or 10% of mixed gas stream 106. Similarly, the oxygen gas can comprise, for example, less than about 90%, 80%, 70%, 60%, 50%, 40%, 30%, 20%, or 10% of mixed gas stream 106. According to other embodiments, the ratio of oxygen to inert gas in mixed gas stream 106 can independently be, for example about 10:90, 20:80, 30:70, 40:60, 50:50, 60:40, 70:30, 80:20, or 90:10. In addition, the ratio of oxygen to inert gas in mixed gas stream 106 can independently vary, for example the ratio can range from about 10:90 to 90:10, 10:90 to 80:20, 10:90 to 70:30, 10:90 to 60:40, 10:90 to 50:50, 10:90 to 40:60, 10:90 to 30:70, 10:90 to 20:80, 20:80 to 90:10, 20:80 to 80:20, 20:80 to 70:30, 20:80 to 60:40, 20:80 to 50:50, 20:80 to 40:60, and 20:80 to 30:70. It is also contemplated that mixed gas stream 106 can comprise trace amounts (e.g., less than 1%) of other gases, for example, argon, carbon dioxide, neon, methane, helium, krypton, hydrogen, xenon, ozone, nitrogen dioxide, iodine, carbon monoxide, and ammonia.

As described herein, oxygen from mixed gas stream 106 can be consumed by the electrochemical reaction taking place at cathode 111. As a result, a depleted mixed gas stream 108 can be output from cathode 111. Depleted mixed gas stream 108 can contain water vapor produced by the electrochemical reaction at cathode 111 and in some embodiments water vapor supplied to cathode 111. The concentration of oxygen in depleted mixed gas stream 108 can be less than mixed gas stream 106 due to the loss of oxygen consumed by the electrochemical reaction. For example, about 1%, 5%, 10%, 20%, 30%, 40%, 50%, 60%, 70%, 80%, 90%, or 100% of the oxygen in mixed gas stream 106 can be consumed by the electrochemical reaction occurring at cathode 111.

According to an exemplary embodiment, substantially zero inert gas can be consumed or lost due to leakage in cathode 111. For example, the moles of inert gas in mixed gas stream 106 entering cathode 111 can be substantially equal to the moles discharged from cathode 111. However, due to the consumption of oxygen from mixed gas stream 106 the concentration of inert gas in depleted mixed gas stream 108 can be greater than the concentration within mixed gas stream 106. For example, inert gas can comprise more than about 90%, 80%, 70%, 60%, 50%, 40%, 30%, 20%, or 10% of the depleted gas stream.

Depleted mixed gas stream 108 can be in fluid communication with separator 105. Separator 105 can be configured to remove at least a portion of the water vapor from depleted mixed gas stream 108. The water vapor removed by separator 105 can be discharged as water recirculation stream 105A. Water recirculation stream 105A can be recycled. Depleted mixed gas stream 108 can be output from water separator 105 to recirculation line 103A also referred to as mixed gas recirculation stream 103. As shown in FIG. 1, recirculation line 103A can be in fluid communication with blending component 104 enabling mixed gas recirculation stream 103 to be combined with inert gas stream 101, oxygen stream 102, or both to form mixed gas stream 106.

As described herein, recirculation system 120 can be configured such that substantially zero inert gas can be consumed or lost within recirculation system 120. Therefore, recirculation system 120 can be configured such that once a steady state baseline volume of inert gas can be established in circulation then only a minimal volume of additional inert gas will need to be added from inert gas stream 101 through blending component 104. The minimal volume of additional inert gas added can be substantially equal to any loss of inert gas in recirculation system 120 due to a variety of reasons. For example, volume reduction due to temperature, piping leaks, and gasket leaks, etc.

According to an exemplary embodiment, recirculation system 120 can be configured such that blending component 104 controls the flow of oxygen from oxygen stream 102 into mixed gas recirculation stream 103 to form mixed gas stream 106. The flow rate of oxygen added to mixed gas recirculation stream 103 can correspond (e.g., be substantially equal) to the quantity of oxygen consumed in cathode 111.

Recirculation system 120 can be configured to add oxygen from oxygen stream 102 continuously or periodically. For example, at steady state, recirculation system 120 can be configured such that oxygen stream 102 can added to mixed gas recirculation stream 103 continuously at a rate equal to the consumption rate of oxygen within cathode 111. Alternatively, recirculation system 120 can be configured such that oxygen is periodically added to mixed gas recirculation stream 103. For example, an oxygen concentration low level set point and an oxygen concentration set point can be selected and recirculation system 120 can be configured to added oxygen when the low level set point is reached and continue adding oxygen until the oxygen concentration set point is reached. The addition of oxygen from oxygen stream 102 can be controlled by one or more flow control devices (e.g., valves).

As shown in FIG. 1, fuel cell module 100 can be configured to supply anode 112 with a hydrogen stream 130 and discharge a depleted hydrogen stream 131 from anode 112. Although not shown in FIG. 1, fuel cell module 100 can be configured to recirculate depleted hydrogen stream 131 and combine it with hydrogen stream 130 in order to recycle unconsumed hydrogen. Such embodiments are described later herein.

Fuel cell 110 as described herein can be a standard modular design and construction. For example, fuel cell 110 as described herein can be installed in a fuel cell module wherein the fuel cell module is configured to supply cathode 111 with ambient air from the surrounding environment rather than a mixture of inert gas and oxygen. Recirculation system 120 as described herein can be configured such that it can be integrated within fuel cell module 100 enabling utilization of standard fuel cell technology and designs (e.g., fuel cell 110) even for applications where drawing ambient air from the surrounding environment is either not practical or possible.

In other embodiments, recirculation system 120 can be integrated directly into fuel cell 110 rather than integrated into fuel cell module 100. In other embodiments, recirculation system 120 can be configured to be an external modular component configured to be coupled to fuel cell module 100 or fuel cell 110, rather than an integral component.

As described herein, fuel cell module 100 and recirculation system 120 can be configured to supply cathode 111 of fuel cell 110 with an inert gas rich stream (i.e., mixed gas stream 106) of which a portion is oxygen. By supplying cathode 111 and fuel cell 110 with an inert gas rich stream (i.e., mixed gas stream 106) rather than a pure oxygen stream the majority of the fluid handling components of fuel cell module 100 can be standard components (e.g., not oxygen certification components) while all of fuel cell 110 fluid handling components can be standard components. In other words, fuel cell module 100 and recirculation system 120 can be configured such that only fluid components handling oxygen stream 102 (i.e., pure oxygen) need to be oxygen certified components because exposure to pure oxygen can be limited to those components.

Furthermore, by supplying cathode 111 and fuel cell 110 with an inert gas rich stream (i.e., mixed gas stream 106) rather than a pure oxygen stream the potential for an explosive mixture forming in fuel cell 110 can be reduced. This reduction can be a result of the fact that in the event a pin hole leak in electrolyte 113 does occur, rather than pure oxygen leaking through the membrane and mixing with hydrogen, instead a nitrogen rich gas stream (i.e., mixed gas stream 106) containing some oxygen may leak across the electrolyte and mix with the hydrogen reducing the likelihood of an explosive mixture being formed.

According to an exemplary embodiment, by recirculating the inert gas and unconsumed oxygen, as described herein, the quantity of oxygen and inert gas utilized for fuel cell operation can be substantially less compared to no recirculation or single pass operation. For example, a cathode receiving a mixed gas wherein the depleted gas is not recirculated will require a significantly larger volume to operate the same fuel cell for the same period.

FIGS. 2 and 3 show schematic diagrams of exemplary embodiments of a fuel cell module 200. Fuel cell module 200 can be similar to fuel cell module 100 as described herein. Fuel cell module 200 can comprise a fuel cell 210 and a cathode recirculation system 220. As shown in FIG. 2, fuel cell 210 can be contained within fuel cell module 200 and cathode recirculation system 220 can be in fluid communication with fuel cell module 200. Fuel cell 210 can comprise a cathode 211, an anode 212 separated by an electrolyte membrane 213, and a cooling element 214. Similar to fuel cell module 100, according to some embodiments, fuel cell module 200 can contain a plurality of fuel cells 210 forming a fuel cell stack within fuel cell module 200. For example, fuel cell module 200 can contain 5, 10, 20, 25, 50, 100, or more fuel cells 210 within fuel cell module 200 contained in parallel with one another.

According to an exemplary embodiment, cathode recirculation system 220 can comprise an inert gas stream 201 configured to be received through an inert gas inlet passage 201A. Cathode recirculation system 220 can further comprise an oxygen stream 202 configured to be received through an oxygen inlet passage 202A. As shown in FIG. 2, inert gas inlet passage 201A and oxygen inlet passage 202A can combine and be in fluid communication with a blending component 204. According to the embodiment shown in FIG. 2, blending component 204 can comprise an ejector 204A. Ejector 204A can be configured to receive inert gas stream 201, oxygen stream 202, or both and mix it with a mixed gas recirculation stream 203. The inert gas stream 201, oxygen stream 202, or both can act as the motive fluid increasing the pressure of the mixed gas recirculation stream 203. The pressure of inert gas stream 201 and oxygen stream 202 can vary. For example, inert gas stream 201 and oxygen stream 202 can be supplied to inlet passages 201A and 202A at, for example, a range of about 0 psi to 100 psi, 100 psi to 200 psi, 200 psi to 300 psi, 300 psi to 400 psi, 400 psi to 425 psi, 425 psi to 450 psi, 450 psi to 475 psi, 475 psi to 500 psi, or great than 500 psi.

Ejector 204A can be configured to discharge a mixed gas stream 206 and supply it to cathode 211. Mixed gas stream 206 can comprise a mixture of inert gas and oxygen same as mixed gas stream 106 described herein. The concentration and ratio of inert gas to oxygen for mixed gas stream 206 can vary same as mixed gas stream 106.

An electrochemical reaction taking place at cathode 211 can consume at least a portion of the oxygen within mixed gas stream 206. As a result, discharged from cathode 211 can be a depleted mixed gas stream 208. Depleted mixed gas stream 208 can contain water vapor produced as a result of the electrochemical reaction at cathode 211. Another product of the electrochemical reaction at cathode 211 can be heat. Therefore, depleted mixed gas stream 208 can be discharged from fuel cell 210 and supplied to a heat exchanger 209 contained within fuel cell module 200.

Heat exchanger 209 can be a tube and shell, plate and frame, or other like heat exchanger configuration. Heat exchanger 209 can cool depleted mixed gas stream 208 by transferring at least a portion of its heat energy to a cooling fluid 209A circulated through heat exchanger 209. The rate of cooling can be controlled by controlling the flow rate of cooling fluid 209A. Temperature of the depleted mixed gas stream 208 exiting heat exchanger 209 can be monitored by temperature transmitter, which can be in communication with a controller configured to adjust the flow rate of cooling fluid 209A in order to achieve a predetermined temperature set point for depleted mixed gas stream 208.

Depleted mixed gas stream 208 exiting heat exchanger 209 can be passed through a separator 205. Separator 205 can be configured to remove water vapor from depleted mixed gas stream 208 and discharge it through a recirculation or vent line 205A. Depleted mixed gas stream 208 can exit separator 205 as mixed gas recirculation stream 203. As shown in FIG. 2, mixed gas recirculation stream 203 can be in fluid communication with ejector 204A enabling mixed gas recirculation stream 203 to be combined with inert gas stream 201, oxygen stream 202, or both to form mixed gas stream 206.

As a result of the pressure drop that occurs through cathode 111, heat exchanger 209, separator 205, and all the interconnecting piping, mixed gas recirculation stream 203 can be at lower pressure than that of mixed gas stream 206 supplied to cathode 111. Accordingly, ejector 204A can be configured to boost the pressure of mixed gas recirculation stream 203 as it passes through ejector 204A by combining it with inert gas stream 201, oxygen stream 202, or both, which act as the motive gas stream in ejector 204A.

According to an exemplary embodiment, as shown in FIG. 2, fuel cell module 200 can be configured to receive a hydrogen stream 230 and a second inert gas stream 231 and either stream or a combination of both streams can be supplied to fuel cell 210. Hydrogen stream 230, a second inert gas stream 231, or both can be supplied to a second ejector 233 within fuel cell 210. Second ejector 233 can be configured to receive hydrogen stream 230, second inert gas stream 231 or both and combine it with a hydrogen recirculation stream 232. Second ejector 233 can be configured to discharge a second mixed gas stream 234 and supply it to anode 212.

Second mixed gas stream 234 can comprise a mixture of inert gas and hydrogen. The concentration and ratio of inert gas to hydrogen can vary. In other embodiments, second mixed gas stream 234 can be almost entirely hydrogen, for example, greater than about 50%, 60%, 70, 80%, 90%, 95%, 98%, or 99% hydrogen. Hydrogen stream 230 and second inert gas stream 231 can be supplied to fuel cell module 200 at a pressure ranging, for example, from about 50 psi to 200 psi, 100 psi to 150 psi, 100 psi to 125 psi, or 125 psi to 150 psi.

An electrochemical reaction taking place at anode 212 can consume at least a portion of the hydrogen within second mixed gas stream 234. As a result, discharge from anode 212 can be a depleted second mixed gas stream 235. Depleted second mixed gas stream 235 can contain some water vapor collected from anode 212. Therefore, depleted second mixed gas stream 235 can be discharged from anode 212 and supplied to a second separator 236.

Second separator 236 can be configured to remove water vapor from second mixed gas stream 235 and discharge it through a recirculation or vent line 237. Depleted second mixed gas stream 235 can be discharged from second separator 236 as hydrogen recirculation stream 232. As shown in FIG. 2, hydrogen recirculation stream 232 can be in fluid communication with second ejector 233 enabling hydrogen recirculation stream 232 to be combined with second inert gas stream 231, hydrogen stream 230, or both to form second mixed gas stream 234.

As shown in FIG. 2, fuel cell 210 can further comprise cooling element 214 in contact with cathode 211. Cooling element 214 can be configured to circulate a cooling fluid 240 in order to control the temperature of cathode 211. In addition, as shown in FIG. 2, fuel cell 210 can further comprise a heating element 250 in line with cooling fluid 240 configured to regulate the temperature of cooling fluid 240.

As shown in FIG. 2, fuel cell module 200 and fuel cell 210 can further comprise a plurality of valves, plurality of instruments, plurality of orifice plates, and fluid communication lines connecting the various components. The plurality of valves can comprise a variety of valve styles, for example, two way valves, three way valves, ball valves, butterfly valves, gate valves, check valves, flow control valves. The plurality of valves can be actuated by a variety of means, for example, spring actuated, electrically actuated, pneumatically actuated, or a combination thereof. The plurality of instruments can comprise a variety of instrument types for measuring a variety of parameters, for examples, temperature, pressure, flow rate, level, humidity, or the like. The plurality of orifices can have a variety of diameters and be configured to reduce the flow rate of the gas flow through the corresponding orifice.

FIG. 3 shows a schematic diagram of a fuel cell module 200 same as FIG. 2 except that ejector 204A has removed and a compressor 260 has been added to cathode recirculation system 220. Compressor 260 can be configured to compress mixed gas recirculation stream 203 and as a result increase the pressure of mixed gas recirculation stream 203 before mixing the stream with inert gas stream 201, oxygen stream 202, or both at blending component 204. According to the exemplary embodiment shown in FIG. 3, inert gas stream 201 and oxygen stream 202 can be at lower pressure because rather than acting as the motive gas though ejector 204A (see FIG. 2), the mixed gas recirculation stream 203 of FIG. 3 is compressed and acts as the motive gas when combined with inert gas stream 201, oxygen stream 202, or a combination of both. For example, inert gas stream 201 and oxygen stream 202 shown in FIG. 3 can be supplied to inlet passages 201A and 202A at, for example, a range of about 0 psi to 5 psi, 5 psi to 10 psi, 10 psi to 15 psi, 15 psi to 20 psi, 20 psi to 25 psi, 25 psi to 30 psi, 30 psi to 40 psi, 40 psi to 50 psi, or great than 50 psi.

Compressor 260 can be configured such that the pressure increase to mixed gas recirculation stream 203 as a result of the compression can correspond to the pressure drop produced by cathode 111, heat exchanger 209, separator 205, and the interconnecting piping. For example, compressor 260 can be configured to increase the pressure of mixed gas recirculation 203 by, for example, a range of about 1 bar to 10 bar, 1 bar to 20 bar, 1 bar to 30 bar, 1 bar to 40 bar, 10 bar to 20 bar, 10 bar to 30 bar, 10 bar to 40 bar, 20 bar to 30 bar, or 20 bar to 40 bar. Compressor 260 can be one of a variety of different compressor types, for example, rotary, reciprocating, centrifugal, axial, or the like. In other embodiments (not shown), compressor 260 can be configured to be external to fuel cell module 200 rather than integrated into the module as shown in FIG. 3.

In yet another embodiment (not shown), fuel cell module 200 can comprise both a compressor 260 and an ejector 204A as described herein.

The fuel cell modules as described herein can enable operation of the one or more fuel cells such that a mixed gas stream is recirculated through the one or more cathodes of the fuel cells within the fuel cell module. FIG. 4 shows a flow chart of a method 400 for operating the fuel cell modules, according to an exemplary embodiment. Method 400 can comprise steps 402, 404, and 406. Step 402 can comprise feeding a mixed gas stream to the cathode, wherein the mixed gas stream comprises oxygen and an inert gas. Step 404 can comprise collecting a depleted mixed gas stream from the cathode. Step 406 can comprise adding oxygen, inert gas, or oxygen and inert gas to the depleted gas stream to produce the mixed gas stream.

Method 400 as described herein can be performed utilizing various inert gases, for example, nitrogen, argon or the like. According to an exemplary embodiment, for method 400, the percentage of oxygen in the mixed gas can be about 21% and the percentage of inert gas can be about 79%. In other embodiments, the percent of oxygen and inert gas making up mixed gas stream 106 can vary. For example, inert gas can comprise less than about 90%, 80%, 70%, 60%, 50%, 40%, 30%, 20%, or 10% of mixed gas stream 106. Similarly, the oxygen gas can comprise, for example, less than about 90%, 80%, 70%, 60%, 50%, 40%, 30%, 20%, or 10% of mixed gas stream 106. According to other embodiments, the ratio of oxygen to inert gas in mixed gas stream can independently be, for example about 10:90, 20:80, 30:70, 40:60, 50:50, 60:40, 70:30, 80:20, or 90:10.

According to an exemplary embodiment, method 400 can further comprise removing water vapor from the depleted mixed gas stream. Water vapor can be removed from the depleted mixed gas stream by passing through a water vapor separator. The water separated from the depleted mixed gas stream can be recycled or discharged from the fuel cell module.

Method 400 can further comprise utilizing the plurality of valves, plurality of transmitters, and the other various flow control components to control the pressure of the various gas streams within the fuel cell module and fuel cell. For example, the valves and transmitters can be used to control the pressure and flow rate of the inert gas stream, oxygen stream, mixed gas stream, depleted mixed gas stream, recirculation stream, second mixed gas stream, depleted second mixed gas stream, hydrogen stream, second inert gas stream, and hydrogen recirculation stream. By controlling the flow of the electrochemical reaction inputs (e.g., hydrogen and oxygen) supplied to the fuel cell, the operation (e.g., the electrical output) of the fuel cell can be controlled.

Step 406 comprising adding oxygen, inert gas or both oxygen and inert gas to the depleted gas stream can be performed by way of passing the gas stream through an ejector (e.g., 204A) wherein the oxygen, inert gas or both oxygen and inert gas stream act as the motive gas stream and become mixed into the depleted gas stream forming the mixed gas stream.

In another embodiment, method 400 can further comprise compressing the recirculation stream and then combing with the oxygen stream, inert gas stream, or both the oxygen and inert gas stream. The depleted gas stream can be compressed using, for example, compressor 260 as described herein.

The fuel cell modules and methods as described herein can be configured for leakage testing and acceptance criteria used for air operation.

Other embodiments of the present disclosure will be apparent to those skilled in the art from consideration of the specification and practice of the present disclosure disclosed herein. It is intended that the specification and examples be considered as exemplary only, with a true scope and spirit of the present disclosure being indicated by the following claims.

What is claimed is:

1. A cathode recirculation system for a fuel cell module, comprising:
an inert gas inlet passage configured to receive inert gas and an oxygen gas inlet passage configured to receive oxygen;
a blending component in fluid communication with the inert gas inlet passage, the oxygen gas inlet passage, and an inlet of at least one cathode; and
a recirculation line in fluid communication with an outlet of the at least one cathode and the blending component configured to recirculate a mixed gas stream containing oxygen and an inert gas;
wherein at least a portion of the mixed gas released from the at least one cathode is recirculated back to the blending component where oxygen, inert gas, or both oxygen and inert gas are introduced into the recirculated mixed gas stream and then supplied to the inlet of the at least one cathode.

2. The system of claim 1, wherein the inert gas is nitrogen.

3. The system of claim 1, wherein the ratio of oxygen to inert gas in the mixed gas stream entering the at least one cathode ranges from about 10:90 to about 40:60.

4. The system of claim 1, further comprising a separator configured to remove water vapor from the mixed gas stream released from the at least one cathode.

5. The system of claim 1, further comprising a plurality of valves, instruments, and controllers configured to control the pressure of the mixed gas stream supplied to the inlet of the at least one cathode.

6. The system of claim 1, wherein the blending component comprises an ejector.

7. The system of claim 1, further comprising a compressor in stream with the recirculation line configured to compress the mixed gas.

8. The system of claim 1, further comprising at least one heat exchanger configured to regulate the temperature of the mixed gas.

9. The system of claim 1, wherein the fuel cell module houses at least one proton exchange membrane fuel cell.

10. The system of claim 1, wherein the moles of oxygen supplied through the blending component to the mixed gas is substantially equal to the moles of oxygen consumed in the at least one cathode.

11. A method of recirculating a mixed gas through a cathode of a fuel cell comprising:
feeding a mixed gas stream to the cathode, wherein the mixed gas stream comprises oxygen and an inert gas;
collecting a depleted mixed gas stream from the cathode; and
adding oxygen, inert gas, or both oxygen and inert gas to the depleted mixed gas stream and recirculating to the inlet of the cathode as the mixed gas stream.

12. The method of claim 11, wherein the inert gas is nitrogen.

13. The method of claim 11, wherein the ratio of oxygen to inert gas in the mixed gas stream entering the at least one cathode ranges from about 10:90 to about 40:60.

14. The method of claim 11, further comprising removing water vapor for the depleted mixed gas stream using a separator.

15. The method of claim 11, further comprising controlling the pressure of the mixed gas stream supplied to the inlet of the at least one cathode.

16. The method of claim 11, further comprising ejecting the oxygen, inert gas, or both into the depleted mixed gas stream through an ejector.

17. The method of claim 11, further comprising compressing the depleted mixed gas stream discharged from the at least one cathode.

18. The method of claim 11, further comprising cooling the depleted mixed gas stream to maintain a temperature set point.

19. The method of claim 11, further comprising controlling the amount of oxygen addition such that the moles of oxygen added to the depleted mixed gas stream corresponds to an amount consumed in the cathode.

20. A fuel cell module housing having at least one fuel cell containing a cathode and an anode, comprising:
an inert gas stream and an oxygen stream;
a blending component in fluid communication with the inert gas stream and the oxygen stream; and
a depleted mixed gas stream released from the cathode of the at least one fuel cell that is in fluid communication with the blending component;
wherein at least a portion of the depleted mixed gas stream released from an outlet of the cathode is recirculated back to the blending component where the inert gas stream, the oxygen stream, or both are configured to be introduced into the depleted mixed gas stream and supplied to an inlet of the cathode.
